(19) United States
(12) Patent Application Publication
(10) Pub. No.: US 2006/0050346 A1
(43) Pub. Date: Mar. 9, 2006

(54) Noise-reducing resonator and laser-scanning unit with the same

(75) Inventor: Jung-Kwon Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/214,851

(22) Filed: Aug. 31, 2005

(30) Foreign Application Priority Data
Aug. 31, 2004 (KR) 2004-69362

(51) Int. Cl. G02B 26/08

(52) U.S. Cl. 359/204

(57) ABSTRACT

A noise-reducing resonator and a laser-scanning unit with the same are provided. The noise-reducing resonator includes: a case having at least two spaces divided by partitions, and one side of which is open; and a cover fixed to the opened side of the case and having at least two holes for communicating each of the spaces with the exterior. An image forming apparatus having a lower operating noise than the conventional art, because the noise may be effectively reduced at a plurality of frequency bands rather than one frequency band. In addition, the resonator may be integrally formed with the laser-scanning unit and formed using the ribs formed at the main body of the laser-scanning unit, thereby reducing the number of parts and facilitating its manufacturing.

### CROSS-REFERENCE TO RELATED APPLICATIONS

This application claims the benefit of Korean Application No. 2004-69362, filed Aug. 31, 2004, in the Korean Intellectual Property Office, the disclosure of which is incorporated herein by reference.

### BACKGROUND OF THE INVENTION

1. Field of the Invention

The present invention relates to a noise-reducing resonator and a laser-scanning unit with the same and, more particularly, to a resonator for reducing noise generated from a laser-scanning unit for exposing a photosensitive body in an image forming apparatus, and a laser-scanning unit integrally formed with the resonator.

2. Description of the Related Art

Since a static type image forming apparatus such as a laser printer among image forming apparatuses has advantages capable of obtaining rapid printing speed, high quality printed matters and low maintenance cost, the static type apparatus has been widely used by companies or personal users requiring a large amount of printing operation.

The static type image forming apparatus employs a method of irradiating light such as a laser beam on a photosensitive drum to form a static latent image, applying and developing a developing agent such as a toner to a surface of the photosensitive drum using a supply roller and a developing roller, transferring it to a recording medium, and settling it to output the printed matter. In this process, a laser-scanning unit is used for irradiating light such as a laser beam, and so on.

FIG. 1 is a schematic plan view illustrating an inner structure of a conventional laser-scanning unit.

Referring to FIG. 1, the conventional laser-scanning unit is provided with an optical system composed of optical components, wherein the optical components include: a laser diode (LD) 10 for emitting a laser beam; a collimator lens 12 converting the emitted laser beam into parallel light or convergence light to a light axis; a polygonal rotating mirror 14 for moving and scanning the laser beam transmitted through the collimator lens 12 in a horizontal direction with a uniform linear velocity; a cylindrical lens 13 for imaging the laser beam on a surface of the polygonal rotating mirror 14 in a horizontal linear shape; an F-θ lens 15 for polarizing the uniform velocity light reflected by the polygonal rotating mirror 14 in a main scanning direction and having a regular refractive index to the light axis, compensating a numerical difference, and focusing on a scanning surface; an imaging reflection mirror 16 for reflecting the laser beam transmitted through the F-θ lens 15 to image on an imaging surface of a photosensitive drum 60 of a printer in a dot shape; a photo sensor 18 for receiving the laser beam to tune horizontal synchronization; and a synchronous signal detecting reflection mirror 17 for reflecting the laser beam toward the synchronous signal detecting photo sensor 18. These optical components are hermetically installed in the housing 50 to prevent the optical components from being contaminated due to impurities such as dusts, flying toner particles or the like.

In addition, a motor 20 is installed in the housing 50 to rotate the polygonal rotating mirror 14 at a uniform speed, and the motor 20 is installed on a circuit board 30. A driving chip 40 made of a semiconductor integrated circuit for driving and controlling the motor 20 is mounted on the circuit board 30. In addition, a circuit board 10 for controlling the laser diode 11 is formed in the housing 50.

Meanwhile, the polygonal rotating mirror 14 is rotated at a very high speed in order to improve a printing speed, as a result, noises such as an operating sound of a driving motor are generated. Therefore, technologies for removing the noises have been developed.

FIG. 2 illustrates a laser-scanning unit having a noise-reducing device. In FIG. 2, only a polygonal rotating mirror 14 of the laser-scanning unit is illustrated for understanding. That is, a driving motor 20 for rotating the polygonal rotating mirror 14 is mounted on a bottom surface of the housing 50 of the laser-scanning unit, and the motor 20 and the mirror 14 is connected by a driving shaft 21. Meanwhile, a resonator 60 having a predetermined volume of space is mounted above the polygonal rotating mirror 14, which is in fluid communication with a space at which the polygonal rotating mirror 14 is located, through a hole 62. In addition, the resonator 60 is fixed to the housing of the laser-scanning unit by bolts 64. Further, as shown in FIG. 3, porous sound absorber 60a is adhered to an inner wall of the resonator 60.

The aforementioned technology reduces the noise using resonance of the resonator 60 and the sound absorber 60a. That is, the resonator 60 reduces the noise by converting sound waves of a frequency band close to the resonance frequency to resonance energy, together with attenuating the sound waves using the porous sound absorber 60a.

However, since the technology reduces the noise of only one frequency band using the resonator, the high speed driving motor cannot obtain a good effect. That is, while the noise of the high speed driving motor is mainly generated from a first rotational component of the driving motor, in the case of a rotational body, the noises having various frequency components such as second, third, and fourth components as well as the first component are generated. Therefore, in the case of the conventional art, since the resonator 60 for reducing only one frequency component is employed, there is less effect of reducing the noise.

In addition, since the resonator 60 is attached to the polygonal rotating mirror 14 itself, the polygonal rotating mirror 14 should be hermetically sealed, and transparent plastic should be used in order to transmit the light reflected on the polygonal rotating mirror 14. As a result, the transparent plastic itself may be contaminated during long time use, and the light source may be also contaminated to deteriorate printing quality. Further, as shown, employment of various parts causes its assembly to be complicated, makes its productivity lower, and increase the manufacturing cost.

### SUMMARY OF THE INVENTION

Additional aspects and/or advantages of the invention will be set forth in part in the description which follows and, in part, will be obvious from the description, or may be learned by practice of the invention.

In order to solve the foregoing and/or other problems, it is an aspect of the present invention to provide a noise-reducing resonator capable of reducing noise of various kinds of frequency components in comparison with a conventional art.

It is another aspect of the present invention to provide a noise-reducing resonator having no necessity of using a transparent case, since the noise may be reduced without sealing a polygonal rotating mirror.

It is still another aspect of the present invention to provide a laser-scanning unit capable of facilitating its manufacture and decreasing manufacturing cost by integrally forming the noise-reducing resonator in a main body.

The foregoing and/or other aspects of the present invention may be achieved by providing a noise-reducing resonator including: a case having at least two spaces divided by at least one partition, and one side of which is opened; and a cover fixed to the opened side of the case and having at least two holes for communicating each of the spaces with the exterior.

In another aspect of the present invention, a sound absorber may be adhered to an inner portion of the space formed by the partitions.

In another aspect of the present invention, the present invention provides the laser-scanning unit, in which the resonator is mounted.

It is another aspect of the present invention to provide a laser-scanning unit including a main body; a light source mounted on the main body to emit light; a light deflector rotatably mounted on the main body to deflect the light emitted from the light source; and an imaging lens for imaging the light deflected from the light deflector, wherein at least one partition is formed in the main body to form at least two spaces divided by the at least one partition, and the laser scanning unit further includes a cover attached to opened sides of the respective spaces and having a hole for communicating the spaces with the exterior.

In an aspect of the present invention, the laser-scanning unit may be readily manufactured and the number of parts may be reduced by forming the resonator in the main body of the laser-scanning unit integrally rather than individually.

In another aspect of the present invention, each partition may be made of a rib projected from a bottom surface of the main body.

In another aspect of the present invention, a sound absorber may be additionally adhered to an inner portion of the space formed by the at least one partition.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic plan view of a conventional laser-scanning unit;

FIG. 2 is a cross-sectional view of a polygonal rotating mirror of the laser-scanning unit shown in FIG. 1;

FIG. 3 is a cross-sectional view illustrating an inner wall of a resonator around the polygonal rotating mirror shown in FIG. 2;

FIG. 4 is a perspective view illustrating an exemplary embodiment of a noise-reducing resonator in accordance with the present invention;

FIG. 5 is a cross-sectional view illustrating the exemplary embodiment shown in FIG. 4; and

FIG. 6 is a perspective view illustrating an exemplary embodiment of a laser-scanning unit, in which the noise-reducing resonator in accordance with the present invention is mounted.

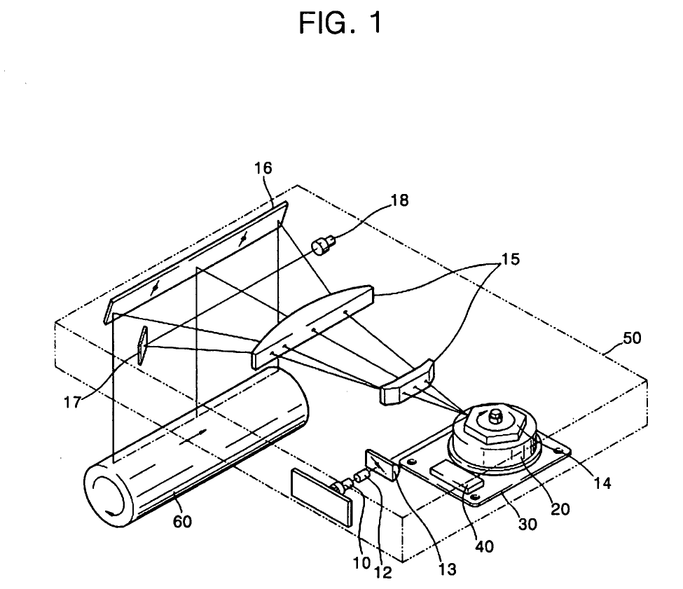

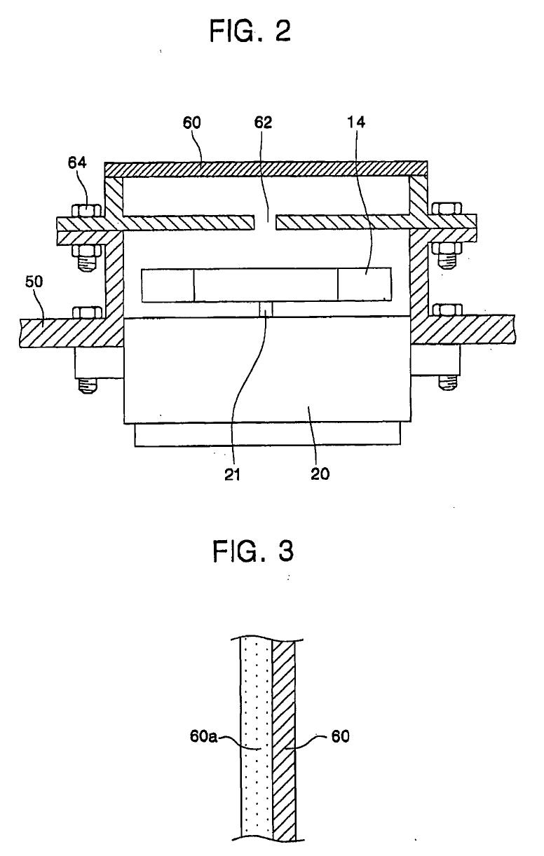

### DETAILED DESCRIPTION OF THE PREFERRED EMBODIMENTS

Reference will now be made in detail to the exemplary embodiments of the present invention, examples of which are illustrated in the accompanying drawings, wherein like reference numerals refer to the like elements throughout. The exemplary embodiments are described below in order to explain the present invention by referring to the figures.

Hereinafter, an exemplary embodiment of a noise-reducing resonator unit and a laser-scanning unit in accordance with the present invention will be described in conjunction with the accompanying drawings.

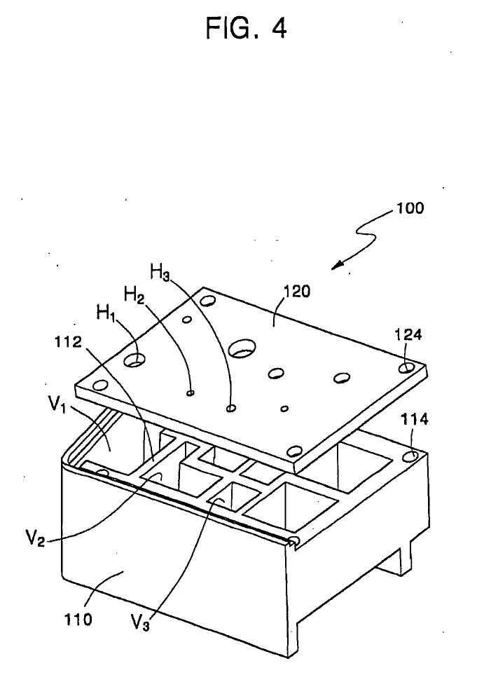

Referring to FIG. 4, an exemplary embodiment of a noise-reducing resonator unit 100 in accordance with the present invention is illustrated. The noise-reducing resonator unit 100 generally includes a case 110 and a cover 120. The case 110 has a rectangular box shape made of injection-molded plastic, one side of which is open. In this process, the case 110 may have a shape such as a circular or polygonal shape, rather than the rectangular shape.

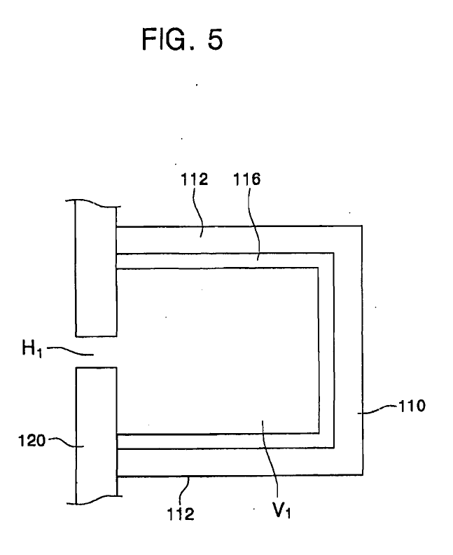

Partitions 112 are formed in the case 110. The partitions 112 can be perpendicularly crossed with each other in the case 110. As a result, an inner portion of the case 110 is divided into a plurality of spaces V1, V2, V3, and so on having different volumes from each other, and each of the spaces has different volumes and shapes. Of course, the partitions 112 may be crossed to have an arbitrary angle, rather than perpendicularly crossed with each other. In addition, a first fastening hole 114 for inserting a bolt or a screw is formed at a corner of the opened side of the case 110. Further, a sound absorber 116 made of a porous material is adhered to inner walls of the respective spaces, as shown in FIG. 5.

Meanwhile, the cover 120 is made of a thin plate and has a plurality of holes H1, H2, H3, and so on passing through the cover 120. The plurality of holes are individually disposed at the plurality of spaces respectively, the respective spaces are sealed by the cover 120 when the cover 120 is coupled with the case 110, and the spaces are in fluid communication with the exterior through only the holes. A second fastening hole 124 in alignment with the first fastening hole 114 is formed at a corner of the cover 120 to fix the cover to the case 110 using a bolt or a screw through the first and second fastening holes 114 and 124. Of course, the cover 120 and the case 110 may be attached by an adhesive agent, and fastened using a fixture such as a hook, rather than fixed by the bolt or screw.

Each of the spaces V1, V2, V3, and so on of noise-reducing resonator unit 100 and each of the holes H1, H2, H3 and so on of noise-reducing resonator unit 100 become a resonator for reducing the noise of one frequency band. Therefore, the noise-reducing resonator unit 100 has the number of the resonators corresponding to the number of the spaces, and each of the resonators has different inherent oscillation frequencies from each other. As described above, the inherent oscillation frequency is adjusted (adapted) to correspond to the frequency band of the noise required to be reduced, which is determined by the volume of the space and the cross-sectional area and the depth of the hole formed at the cover 120.

Generally, the noise generated in the laser scanning unit includes various noises such as noise generated by a friction force between the polygonal rotating mirror and the air, noises of a circuit part required to drive a driving motor and a bearing required to support the polygonal rotating mirror to the motor, noise generated by resonating with the laser scanning unit due to resonance generated by rotation of the driving motor, and so forth. Since the noise has mixed sound characteristics having at least two frequency bands rather than one frequency band, the noise-reducing resonator unit 100 having a plurality of spaces in one case can be employed to reduce the mixed sound.

For example, when the noise having a frequency band of 1000 Hz is required to be reduced using the resonator having the space V1 and the hole H1, where sound velocity is 340 m/sec, in accordance with the formula, the volume of the space and the cross-sectional area and the depth of the hole may be adjusted (adapted) to about 6.3 cm², 0.14 cm², and 0.65 cm, respectively.

Through the aforementioned method, the noise having a plurality of frequency bands may be reduced by analyzing the noise generated in the laser-scanning unit, and by determining the volume of the spaces and the cross-sectional area and the depth of the holes corresponding to the respective frequency bands.

Because each of the spaces functions as one resonator, each space may adjust the frequency of the removable noise by adjusting volumes, cross-sectional areas and depths of each space. In order to reduce the noise having a specific frequency, when the resonator having an inherent oscillation frequency corresponding to the specific frequency is used, the noise corresponding to the frequency is resonated in the resonator to make the air in a center of the resonator extremely active. As a result, sound energy is absorbed by kinetic energy of the air to reduce the noise.

The inherent oscillation frequency of the resonator may be calculated using the following formula.
f=(c/2π)\sqrt{S/(VIₑ)}
f: resonance frequency
c: sound velocity
S: cross-sectional area of hole
V: volume of inner space of resonator
Iₑ: depth of hole

The noise may be reduced by operating the laser scanning unit, analyzing the noise generated in the unit to detect its frequency band, and adjusting (adapting) the volume of the resonator and/or the cross-sectional area and the depth of the hole using the above formula, so that sound energy from the noise can be absorbed.

In this process, the resonator may be adjusted (adapted) to correspond to the frequency band of the noise by making the spaces formed in the case have the same volume, and varying the cross-sectional areas and depths of the respective holes. Alternatively, the resonator may be adjusted (adapted) to the frequency band of the noise by making the respective holes have the same cross-sectional area and depth, and then varying the volumes of the respective spaces. Of course, both methods may be simultaneously performed.

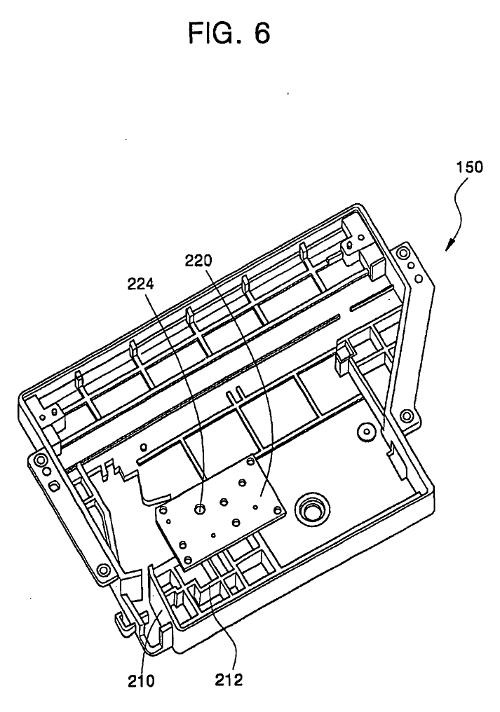

Referring to FIG. 6, an exemplary embodiment of a laser-scanning unit in accordance with the present invention is illustrated. In the exemplary embodiment, components such as a light source, a light deflector, and so on are omitted for understanding. That is, FIG. 6 illustrates only a main body 150 of the laser-scanning unit.

A plurality of ribs are formed at the main body 150 to reinforce the main body 150, a portion of which is a first rib 210 projected in a rectangular box shape, and the other portion of which is a second rib 212 formed in the first rib 210 to divide an inner portion of the first rib 210 into a plurality of spaces. In this connection, the first rib 210 functions as a case of a noise-reducing resonator unit, and the second rib 212 functions as a partition. In addition, the first and second ribs 210 and 212 function to improve strength of the main body 150. Further, the spaces formed by the second rib 212 perform the same function as the inner space of a noise-reducing resonator.

Therefore, the first and second ribs 210 and 212 can be integrally formed with the main body while manufacturing the main body. Meanwhile, a cover 220 is attached on the first and second ribs 210 and 212. The cover 220 also performs the same function as the cover of the aforementioned noise-reducing resonator unit, and has a plurality of holes 224 passing through the cover 220. In this connection, the holes 224 may have a polygonal shape such as a triangle or rectangular shape, rather than a circular shape.

The cover 220 may be fixed using a fixture such as a bolt or a screw, and/or attached by an adhesive agent, and so on. When a light source, a light deflector and an imaging lens are installed in the main body 150 and then a separate cover (not shown) is disposed to seal the main body, the noise generated by rotation of the light deflector or rotation of a driving motor for rotating the light deflector is reduced by the resonators formed by the respective spaces. In addition, a sound absorber may be attached in the spaces of the noise-reducing resonator shown in FIG. 6. Therefore, in this exemplary embodiment, there is no necessity to install a transparent window for transmitting light into the light deflector of the conventional art, since a separate structure for sealing only the light deflector is not necessary.

As can be seen from the foregoing, exemplary embodiments are capable of providing an image forming apparatus having low operating noise in comparison with the conventional art, since the noise may be effectively reduced at a plurality of frequency bands rather than one frequency band.

In addition, the resonator may be integrally formed with the laser-scanning unit, and formed using the ribs formed at the main body of the laser-scanning unit, thereby reducing the number of parts and facilitating its manufacturing.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A noise-reducing resonator unit comprising:
a case having at least two spaces divided by at least one partition, and one side of the case is open; and
a cover fixed to the opened side of the case and having at least two holes for communicating each of the spaces with the exterior.

2. The noise-reducing resonator unit as set forth in claim 1, wherein the spaces formed in the case have the same volume, and the respective holes have different cross-sectional areas and depths.

3. The noise-reducing resonator unit as set forth in claim 1, wherein the respective holes have the same cross-sectional area and depth, and the respective spaces have different volumes.

4. The noise-reducing resonator unit as set forth in claim 1, wherein a sound absorber is additionally adhered to an inner portion of the spaces formed by the at least one partition.

5. A laser-scanning unit employing the noise-reducing resonator unit as set forth in claim 1.

6. A laser-scanning unit comprising:
a main body;
a light source mounted on the main body to emit light;
a light deflector rotatably mounted on the main body to deflect the light emitted from the light source; and
an imaging lens for imaging the light deflected from the light deflector,
wherein at least one partition is formed in the main body to form at least two spaces divided by the at least one partition, and
wherein the laser-scanning unit further includes a cover attached to opened sides of the respective spaces and having at least two holes for communicating the spaces with the exterior.

7. The laser-scanning unit as set forth in claim 6, wherein each partition is made of a rib for increasing strength of the main body.

8. The laser-scanning unit as set forth in claim 6, wherein the spaces formed in the case have the same volume, and the respective holes have different cross-sectional areas and depths.

9. The laser-scanning unit as set forth in claim 6, wherein the respective holes have the same cross-sectional area and depth, and the respective spaces have different volumes.

10. The laser-scanning unit as set forth in claim 6, wherein a sound absorber is additionally adhered to an inner portion of the spaces formed by the at least one partition.

11. The noise-reducing resonator unit as set forth in claim 1, wherein the respective holes have different cross-sectional area and depth, and the respective spaces have different volumes.

12. The laser-scanning unit as set forth in claim 6, wherein the respective holes have different cross-sectional area and depth, and the respective spaces have different volumes.

13. A laser-scanning unit employing the noise-reducing resonator unit as set forth in claim 2.

14. A laser-scanning unit employing the noise-reducing resonator unit as set forth in claim 3.

15. A laser-scanning unit employing the noise-reducing resonator unit as set forth in claim 4.

16. A laser-scanning unit employing the noise-reducing resonator unit as set forth in claim 11.
